(19) United States
(12) Patent Application Publication
(10) Pub. No.: US 2026/0133604 A1
(43) Pub. Date: May 14, 2026

(54) HEAD-MOUNTED DISPLAY DEVICE EQUIPPED WITH COOLING FAN

(71) Applicant: CANON KABUSHIKI KAISHA, Tokyo (JP)

(72) Inventor: YOICHI OSADA, Kanagawa (JP)

(21) Appl. No.: 19/355,155

(22) Filed: Oct. 10, 2025

(30) Foreign Application Priority Data
Nov. 8, 2024 (JP) 2024-196233

(51) Int. Cl. G06F 1/16; G06F 1/20; H04N 13/239; H04N 13/344

(52) U.S. Cl. CPC G06F 1/163; G06F 1/203; H04N 13/239; H04N 13/344; H04N 2213/001

(57) ABSTRACT

A head-mounted display device includes a main unit, an image capturing unit disposed within the main unit, a display unit disposed within the main unit, the display unit including a display element that displays an image captured by the image capturing unit, and a fan disposed within the main unit. A first opening and a second opening are formed in the main unit, the fan is disposed in a flow path that connects the first opening and the second opening, at least a part of the flow path is formed between the image capturing unit and the display element, and in a plan view of the main unit seen from a direction of an optical axis of the image capturing unit, the fan does not overlap the image capturing unit and the display element.

### BACKGROUND

### Field of the Technology

The present disclosure relates to a head-mounted display device, and particularly a head-mounted image display device equipped with a cooling fan.

### Description of the Related Art

An image display device that is worn on a user's head and displays images in front of the user's eyes is used in recent years. Such an image display device enables still images and moving images to be easily viewed as if, for instance, on a large screen, implements stereoscopic vision with ease, and is therefore used as a device that can provide a user with virtual reality (VR) and mixed reality (MR) experiences.

An image display device for implementing MR includes image capturing units that capture images of a subject corresponding to the left and right eyes of the user, display units that superimpose and display the images captured by the image capturing units and 3D CG images generated by a PC or the like, and observation optical systems that project the images to the user. Such an image display device is also called a “video see-through image display device”. In the video see-through image display device, images are displayed on display elements such as liquid crystal panels corresponding to the left and right eyes of the user, and the images are enlarged and projected to the left and right eyes of the user through observation optical systems corresponding to the left and right eyes of the user.

The images captured by the image capturing units have parallax corresponding to the left and right eyes of the user. Furthermore, a parallax image corresponding to the left and right eyes of the user is generated from the 3D CG images, and the generated parallax image is superimposed on the images captured by the image capturing units and displayed on the display units through the observation optical systems. As a result, in the video see-through image display device, virtual 3D CG images are projected to the left and right eyes of the user as if the virtual 3D CG images exist in reality.

Meanwhile, electronic devices such as the image display device described above are known to have cooling fans to suppress excessive temperature rises in components that consume relatively large amounts of power, such as display elements and components mounted on circuit boards disposed in the main units thereof. For example, Japanese Patent Laid-Open No. 2020-68442 proposes an image capturing device that cools a display element by providing a cooling fan within a display unit that includes the display element.

However, with the technique disclosed in Japanese Patent Laid-Open No. 2020-68442, the display element and the fan are disposed within the display unit, which is a movable part, and the weight of the display unit is therefore increased. Wiring is also required to connect the display unit, which is a movable part, to the main unit, on which the display unit is fixed. To avoid such an increase in weight and the addition of wiring, it is necessary to provide a fan within the main unit, but separating the display element and the fan from each other may end up reducing the cooling efficiency of the display element.

Additionally, it is preferable that the fan be disposed in the vicinity of the display element to efficiently cool the display element, and in a video see-through image display device, the fan is preferably disposed between the image capturing unit and the display element. However, when using the technique disclosed in Japanese Patent Laid-Open No. 2020-68442, the distance between the image capturing unit and the display element increases, which causes a shift between the scale of the images captured by the image capturing unit and the scale of the 3D CG images. Images generated by superimposing those images may therefore cause discomfort to a user.

### SUMMARY

Accordingly, the present disclosure has been made in light of the foregoing, and provides an image display device capable of efficiently cooling a display unit while suppressing a worsening in shift between a display magnification of an image captured by an image capturing unit and a display magnification of a generated CG image.

According to some embodiments, a head-mounted display device includes a main unit, an image capturing unit disposed within the main unit, a display unit disposed within the main unit, the display unit including a display element that displays an image captured by the image capturing unit and an optical system that projects the image displayed by the display element onto an eye of a user of the head-mounted display device, and a fan disposed within the main unit, wherein a first opening and a second opening are formed in the main unit, the fan is disposed in a flow path that connects the first opening and the second opening, at least a part of the flow path is formed between the image capturing unit and the display element, and in a plan view of the main unit seen from a direction of an optical axis of the image capturing unit, the fan does not overlap the image capturing unit and the display element.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a state in which an image display device according to a first embodiment is worn by a user.

FIG. 2 is a rear perspective view of the image display device according to the first embodiment.

FIG. 3 is a diagram schematically illustrating a relationship between the image display device and an eyeball of the user according to the first embodiment.

FIG. 4 is a front perspective view illustrating the interior of the image display device according to the first embodiment.

FIG. 5 is a front perspective view of the image display device according to the first embodiment.

FIG. 6 is a diagram illustrating an example of a cross-section of the image display device according to the first embodiment.

FIG. 7 is a diagram illustrating the relative positions of image capturing units and display units of the image display device according to the first embodiment.

FIG. 8 is a diagram illustrating an example of a cross-section of the image display device according to modification 1.

FIG. 9A is a schematic diagram illustrating an image display device according to modification 2.

FIG. 9B is a schematic diagram illustrating an image display device according to modification 3.

FIG. 10 is a diagram illustrating an example of a cross-section of an image display device according to a second embodiment.

FIG. 11 is a diagram illustrating an example of a cross-section of the image display device according to modification 4.

### DESCRIPTION OF THE EMBODIMENTS

Modes for carrying out the technique of the present disclosure will be described in detail hereinafter with reference to the accompanying drawings. Note that the embodiments described hereinafter are merely examples of means for carrying out the present disclosure, and may be modified or changed as appropriate in light of the configurations of apparatuses in which the present disclosure is applied, various conditions, and the like. The embodiments can also be combined as appropriate.

### First Embodiment

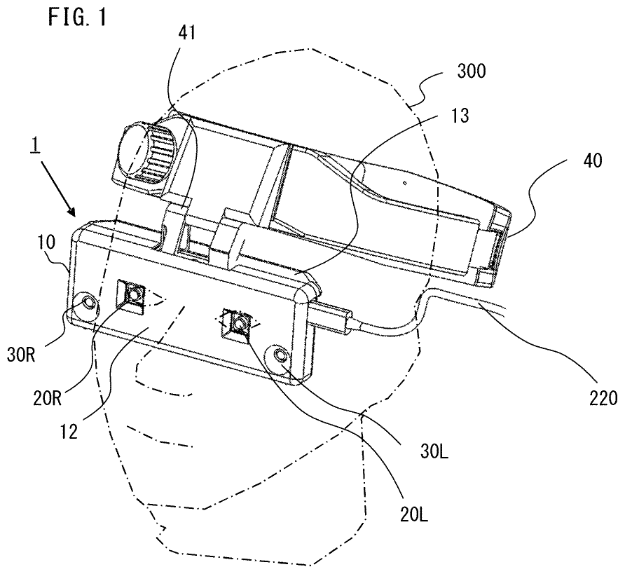

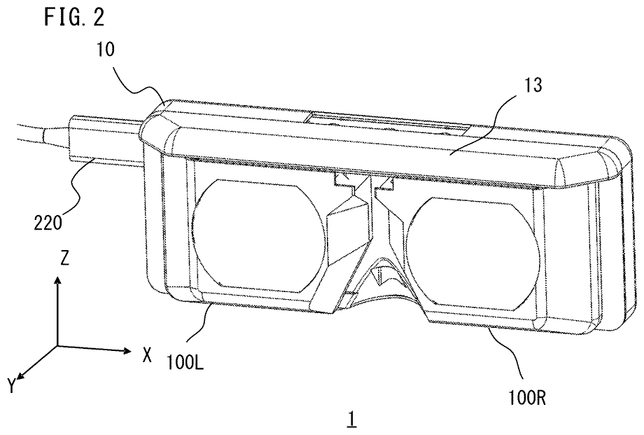

FIG. 1 illustrates a video see-through type image display device 1 (hereinafter simply referred to as an “image display device 1”) according to a first embodiment. FIG. 2 is a perspective view of the image display device 1 from the rear side. Furthermore, in the following descriptions, a coordinate system having X, Y, and Z axes orthogonal to each other is set for the image display device 1, as illustrated in FIG. 2. The X-axis is an axis that extends in the horizontal direction (the left-right direction) when a main unit 10 of the image display device 1 is arranged in the horizontal direction. The Z-axis is an axis that extends in the direction of gravity (the up-down direction).

As illustrated in FIG. 1, a user 300 observes an image displayed in the image display device 1 by wearing the image display device 1 on their head. The image display device 1 is constituted by the main unit 10 and display units 100L and 100R. The main unit 10 is provided with a front cover 12 on a front side, a rear cover 13 on a rear side, left and right image capturing cameras 20L and 20R on the front side, and left and right positioning cameras 30L and 30R on the front side. The image capturing cameras 20L and 20R are image capturing units that are disposed in the main unit 10, and function as a stereo camera that obtains a real image of the surroundings of the image display device 1. The positioning cameras 30L and 30R obtain a position and an orientation of the image display device 1 from the obtained image using feature points such as markers, edges of objects, or the like present around the image display device 1.

In the image display device 1 according to the present embodiment, the image capturing cameras 20L and 20R and the positioning cameras 30L and 30R are provided for the left and right eyes, respectively, of the user. The positioning cameras 30L and 30R are cameras that generate monochromatic images, and are capable of high-precision, highly fault-tolerant positioning using a wide angle of view, a high shutter speed, a long baseline length, and the like. However, the image display device 1 can also obtain display images and obtain positioning information using the image capturing cameras 20L and 20R.

In addition, a range sensor or the like using ultrasonic waves, infrared rays, or the like may be used instead of the positioning cameras 30L and 30R. The image display device 1 is connected to a head attachment 40, and the image display device 1 can be pivoted about a rotation shaft 41 formed in the head attachment 40. When the user is wearing the image display device 1 on their head, the main unit 10 can be positioned facing the user's face, as illustrated in FIG. 1, when the user is observing images, whereas the main unit 10 can be pivoted upward above the user's head when the user is not observing images.

The pair of left and right display units 100L and 100R are provided on the rear side of the image display device 1, and the user can observe images with both eyes by looking at the left-eye display unit 100L and the right-eye display unit 100R with the corresponding eyes. The horizontal positions of the display units 100L and 100R can be moved with respect to the main unit 10, which makes it possible to adjust the interpupillary distance (IPD) on a user-by-user basis.

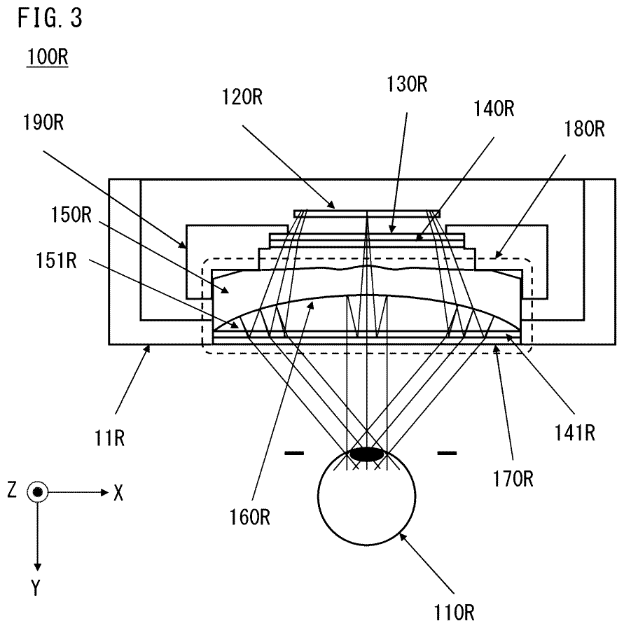

FIG. 3 is a diagram schematically illustrating a relationship between a horizontal cross-section of the display unit 100R and a right eye 110R of the user. The configuration of the display unit 100R for the right eye of the user will be described with reference to FIG. 3. Note that in FIG. 3, parts of the display unit 100R that are not necessary for these descriptions are not illustrated. Furthermore, the left-eye display unit 100L and the right-eye display unit 100R have the same configuration, and thus the following will describe only the right-eye display unit 100R, and not the left-eye display unit 100L.

The display unit 100R projects an image onto the right eye 110R of the user by magnifying and projecting an original image displayed in a display element 120R as a virtual image. The display unit 100R includes an optical system that folds an optical path through polarization, and the optical path will be described hereinafter.

First, as illustrated in FIG. 3, a polarizing plate 130R and a first phase plate 140R are arranged between the display element 120R and a lens 150R in that order from the display element 120R side to the lens 150R side, and a half mirror 160R is vapor-deposited on the lens 150R, on the side thereof where a lens 151R is located. The surface on which the half mirror 160R is vapor-deposited functions as a semi-transmissive reflective surface. In the present embodiment, the polarizing plate 130R and the first phase plate 140R are integrated and fixed to a lens barrel 190R. Next, a second phase plate 141R and a PBS 170R of a polarization separation element are arranged between the lens 151R and the right eye 110R of the user, in that order from the display element 120R side. The second phase plate 141R and the PBS 170R are planar in shape.

The first phase plate 140R and the second phase plate 141R are wavelength plates having a phase difference of λ/4. The second phase plate 141R is held in contact with the lens 151R. In the present embodiment, the second phase plate 141R and the PBS 170R are integrated and affixed to the lens 151R. The lens 150R and the lens 151R are joined to each other and, together with the second phase plate 141R and the PBS 170R, constitute a lens unit 180R. The lens unit 180R is fixed to the lens barrel 190R, and the outside of the lens barrel 190R is covered by a hood 11R. The display element 120R is assembled with the display unit 100R having been adjusted to conform to the optical axis and tilt of the lens unit 180R.

The polarization direction through which the polarizing plate 130R transmits light and the slow axis of the first phase plate 140R are tilted 45° to each other, and the polarization direction through which the PBS 170R transmits light and the slow axis of the second phase plate 141R are tilted 45° to each other. The polarization direction through which the polarizing plate 130R transmits light and the polarization direction through which the PBS 170R transmits light are orthogonal to each other.

In the display unit 100R having the above-described configuration, light emitted from the display element 120R passes through the polarizing plate 130R to become linear polarized light, and passes through the first phase plate 140R to become circular polarized light. The light then passes through the half mirror 160R and the second phase plate 141R to become linear polarized light (first linear polarized light). Because the polarization direction of the linear polarized light is orthogonal to the polarization direction of light transmitted by the PBS 170R, the linear polarized light is reflected by the PBS 170R and passes through the second phase plate 141R to become circular polarized light. The light is then reflected by the half mirror 160R and passes through the second phase plate 141R to become linear polarized light (second linear polarized light).

However, because the polarization direction of the linear polarized light here coincides with the polarization direction of light transmitted by the PBS 170R, the light is transmitted by the PBS 170R and is directed to the right eye 110R of the user. The right eye 110R of the user substantially coincides with an exit pupil of the display unit 100R. In the image display device 1 according to the present embodiment, employing an optical system that folds the optical path using polarization in the display unit 100R in this manner enables the display unit 100R to be made thinner and shorten the focal length thereof, which in turn makes it possible for the user to observe images at a wide angle of view.

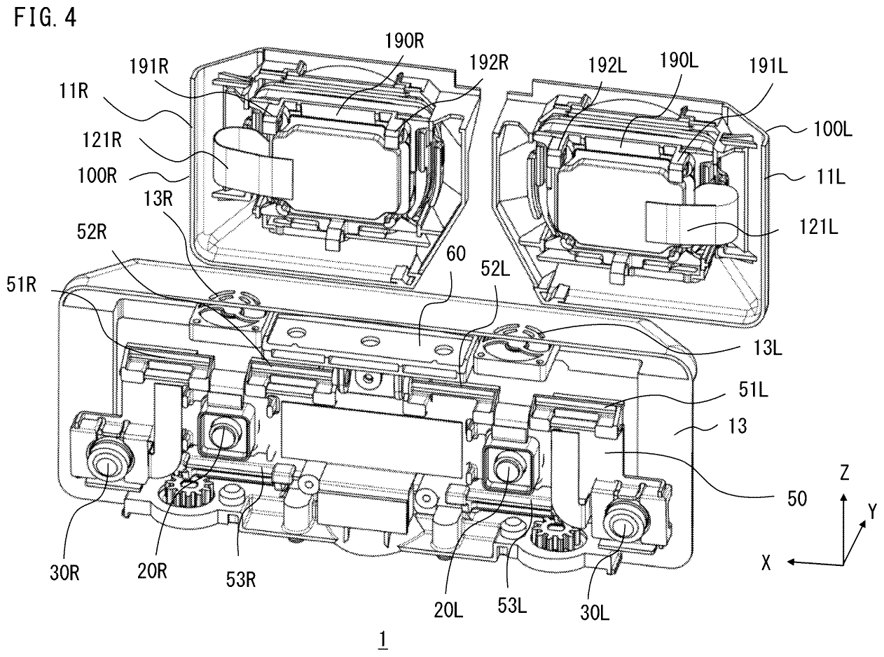

The configuration of the image display device 1 will be described next with reference to FIG. 4. FIG. 4 is a front perspective view illustrating the interior of the image display device 1. Although not shown in FIG. 4, display elements 120L and 120R are assembled with lens barrels 190L and 190R, and wiring 121L and 121R of the display elements 120L and 120R are drawn out to the left and right to be connected to a circuit board 200 (described later). Grooves 191L, 191R, 192L, 192R, 193L, and 193R are provided in the lens barrels 190L and 190R. The image capturing cameras 20L and 20R and the positioning cameras 30L and 30R are affixed to a chassis 50 with adhesive.

Here, the rotation direction and the like of each of the right-eye camera and the left-eye camera are fixed after being adjusted such that the optical axes and the tilts coincide with each other. Here, the optical axis of the camera is an axis that extends in the Y-axis direction in FIG. 4. Instead of a resin, a metal material is employed for the chassis 50 to minimize expansion and shrinkage due to heat. The chassis 50 is integrally molded with a resin part that constitutes the main unit 10, and the chassis 50 is provided with arm parts 51L, 51R, 52L, 52R, 53L, and 53R.

The chassis 50 is supported by a rotation shaft (not shown) at a joint 60 and is held so as to be capable of rotation about the rotation shaft. The joint 60 is fixed to the rear cover 13 by a screw 203 (described later). Each of the arm parts 51L, 51R, 52L, 52R, 53L, and 53R provided in the chassis 50 is fitted with a corresponding one of the grooves provided in the lens barrels 190L and 190R. As a result, the display units 100L and 100R are held so as to be capable of moving in the left-right direction (the X-axis direction) in a state where the hoods 11L and 11R are attached.

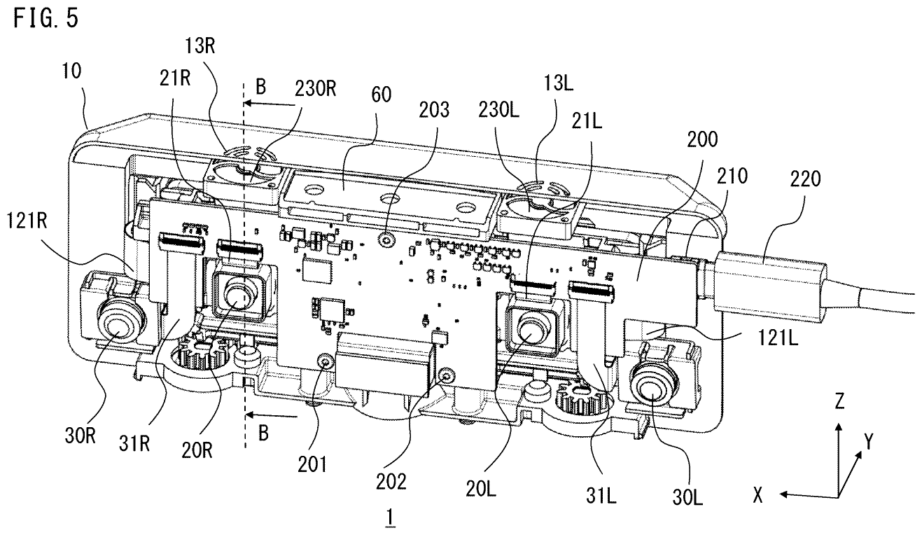

FIG. 5 is a front perspective view of the image display device 1 in a state where the front cover 12 has been removed from the main unit 10. As illustrated in FIG. 5, the image capturing cameras 20L and 20R, the positioning cameras 30L and 30R, and wiring 21L, 21R, 31L, 31R, 121L, and 121R from the display elements 120L and 120R are connected to the circuit board 200 through connectors. The circuit board 200 is fixed to the rear cover 13 by three screws 201, 202, and 203. The joint 60 is tightened by the screw 203.

A connector 210 is mounted on the circuit board 200, and the image display device 1 is supplied with power, and communicates data with the PC, over a cable 220. A pair of left and right cooling fans 230L and 230R are disposed at the top of the image display device 1. The fans 230L and 230R have a rotation axis parallel to the thickness direction of the main unit 10 (in the figure, the Z-axis direction), and are configured to be capable of rotating about the rotation axis. By rotating, the fans 230L and 230R draw air from one side to the other side of the main unit 10 in the thickness direction.

By attaching the front cover 12 to the rear cover 13 illustrated in FIG. 1, the chassis 50 held so as to be capable of rotating with respect to the joint 60 is fixed in a front-back direction, and each constituent element of the main unit 10 is set in a predetermined position.

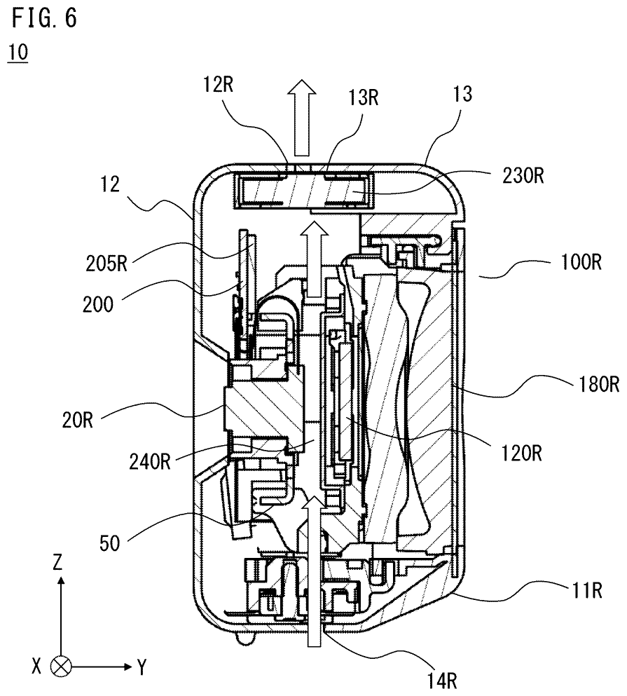

Next, FIG. 6 illustrates a cross-sectional view of the main unit 10 along a line B-B in FIG. 5. The cross-section along the line B-B is a cross-section along a plane parallel to a YZ plane relative to the right eye side of the main unit 10, but the cross-section for the left eye side of the main unit 10 has the same configuration. Accordingly, the cross-section for the right eye side of the main unit 10 will be described hereinafter, and the cross-section for the left eye side will not be described. In FIG. 6, the arrows schematically illustrate the flow of air in the main unit 10 (described later).

As illustrated in FIG. 6, the image capturing camera 20R and the display element 120R are distanced from each other at a predetermined interval in the Y-axis direction, and are disposed such that the rear surfaces thereof face each other. As a result, a partial flow path 240R of an air flow path within the main unit 10 is formed between the image capturing camera 20R and the display element 120R. The circuit board 200 is arranged such that the surface of the board (in the figure, a plane parallel to the XZ plane) is parallel to the display surface of the display element 120R (in the figure, a plane parallel to the XZ plane). The circuit board 200 is provided with an integrated circuit 205R as an example of an electronic component mounted on the circuit board.

The fan 230R is disposed at the top of the image display device 1, and holes 12R and 13R, which are openings for allowing air to pass through, are formed in the top surfaces of the front cover 12 and the rear cover 13, respectively. A hole 14R, which is an opening for allowing air to pass through, is formed in the bottom surface of the main unit 10. The air flow path from the holes 14R, through the flow path 240R between the image capturing camera 20R and the display element 120R, and to the hole 12R and 13R is not blocked, and is a single connected space. The fan 230R is disposed within the flow path inside the main unit 10.

The image capturing camera 20R, the display element 120R, and the integrated circuit 205R each consume a relatively large amount of power compared to the other constituent elements, and produce heat, when the image display device 1 is in use. The image capturing camera 20R, the display element 120R, and the integrated circuit 205R have an upper limit in terms of temperature, which rises as a result of this heat, and it is therefore necessary to ensure that the upper limit temperature is not exceeded when the image display device 1 is in use.

The power consumptions, the upper limit temperatures, and the cooling priorities of the image capturing camera 20R, the display element 120R, and the integrated circuit 205R according to the present embodiment are indicated in Table 1.

TABLE 1

| | | COMPONENT | |
|---|---|---|---|
| | POWER CON- | UPPER LIMIT | COOLING |
| | SUMPTION | TEMPERATURE | PRIORITY |
| DISPLAY | HIGH | LOW | HIGH |
| ELEMENT | | | |
| IMAGE CAP- | HIGH | MIDDLE | MIDDLE |
| TURING CAMERA | | | |
| INTEGRATED | HIGH | HIGH | LOW |
| CIRCUIT | | | |

As indicated in Table 1, the image capturing camera 20R, the display element 120R, and the integrated circuit 205R consume equally high amounts of power. However, among the upper limit temperatures of the image capturing camera 20R, the display element 120R, and the integrated circuit 205R (“component upper limit temperature” in the figures), the upper limit temperature of the integrated circuit 205R is the highest, followed by the upper limit temperature of the image capturing camera 20R, and the upper limit temperature of the display element 120R is the lowest.

Accordingly, among the image capturing camera 20R, the display element 120R, and the integrated circuit 205R, the display element 120R has the highest cooling priority, followed by the image capturing camera 20R, and the integrated circuit 205R has the lowest cooling priority. In the example in FIG. 6, the fan 230R is disposed on the downstream side in the direction in which the air flows through the flow path, and is configured to send the air from the flow path to the outside of the main unit 10. As indicated by the arrows, rotating the fan 230R causes air outside the main unit 10 to flow upward from the bottom of the main unit 10 through the hole 14R, and then to the outside of the main unit 10 through the holes 12R and 13R. The image capturing camera 20R and the display element 120R are disposed on the upstream side of the air flow path within the main unit 10, and the integrated circuit 205R is disposed on the downstream side of the flow path. Accordingly, the image capturing camera 20R and the display element 120R are disposed further on the upstream side than the integrated circuit 205R.

As a result, outside air taken in through the hole 14R in the main unit 10 flows upward through the flow path 240R between the display element 120R, which has the highest cooling priority, and the image capturing camera 20R, which has the next-highest cooling priority, and draws the heat produced by the display element 120R and the image capturing camera 20R upward. The air then passes by the integrated circuit 205R, which has the lowest cooling priority, draws the heat produced by the integrated circuit 205R, and is then discharged by the fan 230R to the outside of the main unit 10 through the holes 12R and 13R.

According to the foregoing configuration, in the image display device 1 according to the present embodiment, it is not necessary to secure a space for placing the fan 230R between the image capturing camera 20R and the display element 120R. This makes it possible to suppress an increase in the shift in the display magnification between a captured image obtained by the image capturing camera 20R and a CG image generated by the image display device 1 and superimposed on the captured image. This in turn makes it possible to display an image that is closer to what the user wearing the image display device 1 sees. Furthermore, in the image display device 1, constituent elements that produce heat, such as the image capturing camera 20R, the display element 120R, the integrated circuit 205R, and the like, can be more efficiently cooled.

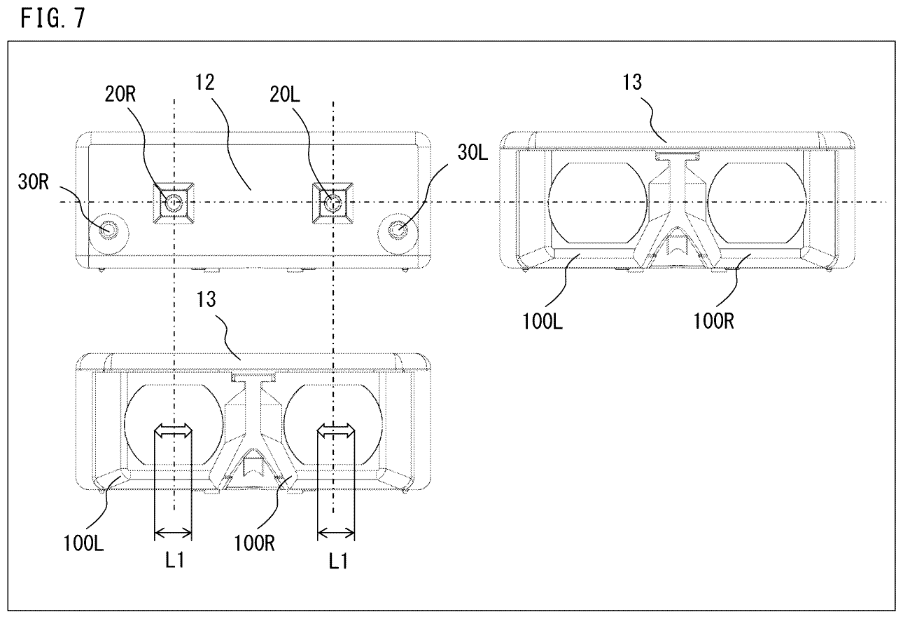

FIG. 7 is a diagram schematically illustrating the optical axes of the image capturing cameras 20L and 20R and the ranges over which the left and right positions of the display units 100L and 100R can be adjusted. In the present embodiment, the display units 100L and 100R of the image display device 1 are configured to be capable of moving in the left-right direction (the X-axis direction) in accordance with the interpupillary distance of the user. Accordingly, as illustrated in FIG. 7, the display centers of the display surfaces (surfaces parallel to the XZ plane) of the display elements 120R and 120L can move within an adjustment range LI of the display centers (within a predetermined range) relative to the main unit 10.

As illustrated in FIG. 7, the optical axes of the image capturing cameras 20L and 20R coincide with the vertical centers of the display units 100L and 100R, and fall within the adjustment range LI of the display centers of the display units 100L and 100R with respect to the left-right direction. This makes it possible to minimize shift between the optical axis of the image capturing camera 20R and the display center of the display unit 100R. Here, it is assumed that the left-right positions of the display units 100L and 100R can be adjusted according to the interpupillary distance of the user, but the left-right positions of the display units 100L and 100R do not necessarily need to be configured so as to be adjustable. For example, if the display units 100L and 100R cannot be moved within the main unit 10, the optical axes of the image capturing camera 20L and the display unit 100L, and the optical axes of the image capturing camera 20R and the display unit 100R, are caused to coincide. This makes it possible for the image display device 1 to reduce shift between the captured image obtained by the image capturing camera 20R and the CG image generated by the image display device 1 and superimposed on the captured image.

### Modification 1

An image display device according to modification 1 on the first embodiment will be described next. In the following descriptions, the same configurations as those of the image display device 1 according to the first embodiment will be given the same reference signs, and will not be described in detail.

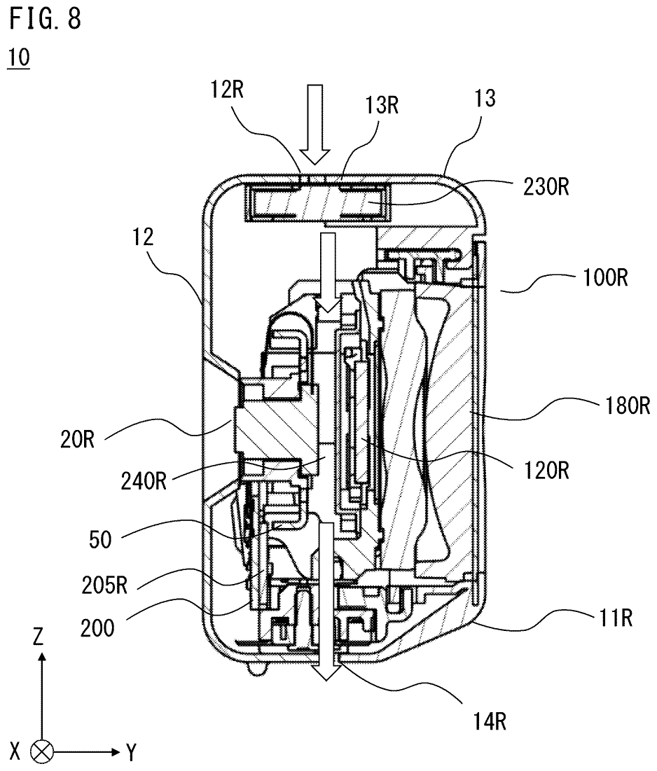

FIG. 8 is a cross-sectional view of the main unit 10 of the image display device 1 according to the present modification. FIG. 8 is a diagram corresponding to the cross-sectional view in FIG. 6 and described in the first embodiment. In the first embodiment, the fan 230R is operated such that air taken in from outside the main unit 10 flows between the display element 120R and the image capturing camera 20R, which have high cooling priorities. However, in the image display device 1 according to the present modification, the integrated circuit 205R is disposed lower than the display element 120R, as illustrated in FIG. 8. Accordingly, the fan 230R may be operated such that air taken in from outside the main unit 10 flows from above to below, as indicated by the arrow in FIG. 8.

In the present modification, the fan 230R is disposed on the upstream side in the direction in which the air flows in the flow path, and is configured to send air from outside the main unit 10 to the flow path. Meanwhile, the image capturing camera 20R and the display element 120R are disposed on the downstream side of the air flow path within the main unit 10, and the integrated circuit 205R is disposed on the upstream side of the flow path. As such, the image capturing camera 20R and the display element 120R are disposed further on the downstream side than the integrated circuit 205R.

Accordingly, in the image display device 1 according to the present modification, outside air is blown in by the fan 230R from the holes 12R and 13R in the main unit 10. The air blown in by the fan 230R passes along the flow path 240R between the display element 120R and the image capturing camera 20R, which have higher cooling priorities, draws heat produced by the display element 120R and the image capturing camera 20R therefrom, and flows downward. The air then passes by the integrated circuit 205R, which has the lowest cooling priority, draws the heat produced by the integrated circuit 205R, and is then discharged to the outside of the main unit 10 through the hole 14R. The image display device 1 according to the present modification can therefore achieve the same effects as that of the first embodiment.

Note that the present modification assumes a case where the holes 12R and 13R are provided in the top surfaces of the front cover 12 and the rear cover 13. However, the holes 12R and 13R may be provided in surfaces of the main unit 10 other than the top surface, such as the front surface, the rear surface, side surfaces, or the like, as long as the holes 12R and 13R connect the air flow path within the main unit 10 to the outside of the main unit 10. Additionally, the fan 230R sends the air from one surface to another surface in the thickness direction, i.e., the direction in which the rotation axis extends. However, a fan having a structure in which air flows to a side surface using the centrifugal force of rotation, e.g., a centrifugal fan, a blower fan, or the like, may be used as the fan 230R instead.

Additionally, the present modification assumes a case where the fan 230R is disposed at the top of the main unit 10. However, the fan 230R may be disposed at the bottom of the main unit 10 instead of the top, or a set of fans may be provided, with the fan 230R and another fan disposed at the top and bottom of the main unit 10, respectively. Note that if fans are disposed at the top and the bottom of the main unit 10, air from outside the main unit 10 is sucked in by one fan, and the air within the main unit 10 is discharged to the outside by the other fan.

### Modification 2

An image display device according to modification 2 on the first embodiment will be described next. In the following descriptions, the same configurations as those of the image display devices 1 according to the first embodiment and the modification 1 will be given the same reference signs, and will not be described in detail.

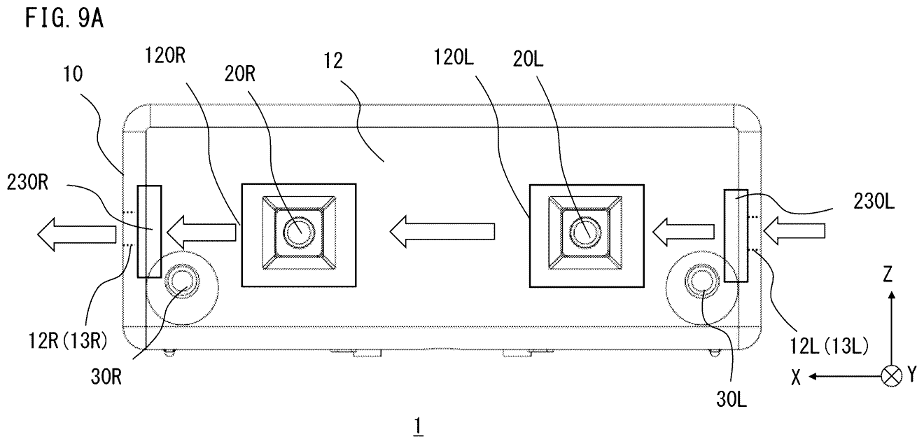

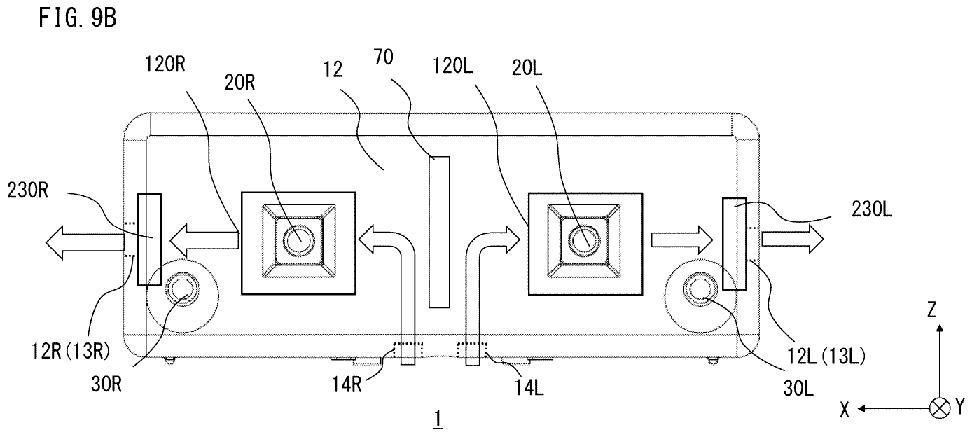

FIG. 9A is a diagram schematically illustrating a configuration in which the fans 230L and 230R are disposed in side surfaces of the main unit 10 (surfaces parallel to the YZ plane on the left and right). As illustrated in FIG. 9A, in the image display device 1 according to the present modification, two fans 230R and 230L are disposed in the side surfaces of the main unit 10. Holes 12R and 13R similar to those in the first embodiment and the modification 1 are formed in the main unit 10, in positions opposing the fan 230R. Likewise, holes 12L and 13L similar to those in the first embodiment and the modification 1 are formed in the main unit 10, in positions opposing the fan 230L.

In the example illustrated in FIG. 9A, air outside the main unit 10 is sucked in by the fan 230L disposed on the left eye side. The air sucked into the main unit 10 from the holes 12L and 13L by the fan 230L flows between the display element 120L and the image capturing camera 20L, and between the display element 120R and the image capturing camera 20R. The air is then discharged to outside the main unit 10 from the holes 12R and 13R by the fan 230R disposed on the right eye side. Note that although the integrated circuit 205R is not shown in FIG. 9A, the integrated circuit 205R is preferably disposed between the display element 120R and the fan 230R on the right eye side, for example.

### Modification 3

An image display device according to modification 3 on the first embodiment will be described next. In the following descriptions, the same configurations as those of the image display devices 1 according to the first embodiment, the modification 1, and the modification 2 will be given the same reference signs, and will not be described in detail.

FIG. 9B is a diagram schematically illustrating a configuration in which the fans 230L and 230R are disposed in side surfaces of the main unit 10. However, unlike the modification 2, in the present modification the fan 230L disposed on the left eye side and the fan 230R disposed on the right eye side are each configured to discharge air present within the main unit 10 to the outside of the main unit 10. As illustrated in FIG. 9B, in the image display device 1 according to the present modification, two fans 230R and 230L are disposed in the side surfaces of the main unit 10. The holes 12L and 13L are formed in the main unit 10 at positions opposing the fan 230L. Likewise, the holes 12R and 13R are formed in the main unit 10 at positions opposing the fan 230R. Furthermore, the hole 14R similar to that in the first embodiment and the modification 1, and a hole 14L similar to the hole 14R, are formed in the bottom surface of the main unit 10.

In FIG. 9B, a wall 70 that blocks the air flow path is disposed in the center of the interior of the main unit 10. As a result, the air flowing into the main unit 10 from the hole 14L flows in a gap between the display element 120L and the image capturing camera 20L on the left eye side due to the wall 70. Likewise, the air flowing into the main unit 10 from the hole 14R flows in a gap between the display element 120R and the image capturing camera 20R on the right eye side due to the wall 70. As a result, the air flowing between the display element 120L and the image capturing camera 20L, and the air flowing between the display element 120R and the image capturing camera 20R, do not mix with each other. This can be expected to provide an effect of increasing the cooling efficiency of the display elements 120L and 120R and the image capturing cameras 20L and 20R by the air taking in from outside the main unit 10. Note that although the integrated circuit 205R is not shown in FIG. 9B, the integrated circuit 205R is preferably disposed between the display element 120R and the fan 230R on the right eye side, for example.

Accordingly, with the image display device 1 according to the first embodiment and the modifications thereon, the fan 230R does not overlap the image capturing camera 20R and the display element 120R projected in the direction of the optical axis of the image capturing camera 20R (the Y-axis direction) in plan view (i.e., when viewing the image display device 1 in the Y-axis direction). The arrangement of the fans and holes is not limited to that described above, and can be changed as appropriate, as long as the configuration is such that the air taken in from outside the main unit 10 preferentially passes the display element 120R, which has the highest cooling priority. Additionally, although the foregoing assumes an example in which the integrated circuit 205R is mounted on the circuit board 200, the components on the circuit board 200 to be cooled are not limited to the integrated circuit 205R, and may be any mounted components that need to be cooled.

### Second Embodiment

An image display device according to a second embodiment will be described next. In the following descriptions, the same configurations as those of the image display device 1 according to the first embodiment will be given the same reference signs, and will not be described in detail.

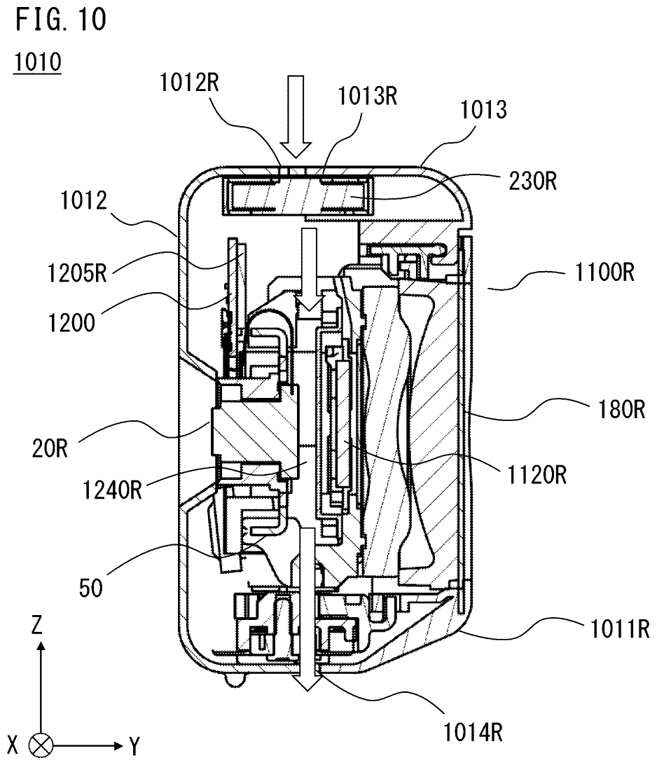

FIG. 10 is a cross-sectional view of an image display device 1000 according to the second embodiment. As illustrated in FIG. 10, the image display device 1000 according to the present embodiment includes a main unit 1010, a front cover 1012, a rear cover 1013, holes 1012R, 1013R, and 1014R, a hood 1011R, and a display unit 1100R. A display element 1120R, a circuit board 1200, and an integrated circuit 1205R are also provided in the main unit 1010. These constituent elements correspond to the main unit 10, the front cover 12, the rear cover 13, the holes 12R, 13R, and 14R, the hood 11R, the display unit 100R, the display element 120R, the circuit board 200, and the integrated circuit 205R, respectively, of the image display device 1 according to the first embodiment. The cross-sectional view in FIG. 10 is a diagram corresponding to FIG. 6 referred to in the first embodiment, and the cross-section of the main unit 1010 on the left eye side has the same configuration. The other constituent elements of the image display device 1000 not shown in FIG. 10 are the same as those of the image display device 1 according to the first embodiment, and will therefore not be described in detail hereinafter.

As illustrated in FIG. 10, the image capturing camera 20R and the display element 1120R are distanced from each other at a predetermined interval in the Y-axis direction, and are disposed such that the rear surfaces thereof face each other. As a result, a partial flow path 1240R of an air flow path within the main unit 1010 is formed between the image capturing camera 20R and the display element 1120R. The circuit board 1200 is arranged such that the surface of the board (in the figure, a plane parallel to the XZ plane) is parallel to the display surface of the display element 1120R (in the figure, a plane parallel to the XZ plane). The integrated circuit 1205R, which is an example of a mounted component, is provided on the circuit board 1200.

The fan 230R is disposed at the top of the image display device 1000, and the holes 1012R and 1013R, which are openings for allowing air to pass through, are formed in the top surfaces of the front cover 1012 and the rear cover 1013, respectively. The hole 1014R, which is an opening for allowing air to pass through, is formed in the bottom surface of the main unit 1010. The air flow path from the gap between the image capturing camera 20R and the display element 1120R to the fan 230R is not blocked, and is connected as a single space.

As in the first embodiment, the image capturing camera 20R, the display element 1120R, and the integrated circuit 1205R have an upper limit in terms of temperature, which rises as a result of this heat, and it is therefore necessary to ensure that the upper limit temperature is not exceeded when the image display device 1000 is in use.

The power consumptions, the upper limit temperatures, and the cooling priorities of the image capturing camera 20R, the display element 1120R, and the integrated circuit 1205R according to the present embodiment are indicated in Table 2.

TABLE 2

| | | COMPONENT | |
|---|---|---|---|
| | POWER CON- | UPPER LIMIT | COOLING |
| | SUMPTION | TEMPERATURE | PRIORITY |
| DISPLAY | HIGH | HIGH | LOW |
| ELEMENT | | | |
| IMAGE CAP- | HIGH | MIDDLE | MIDDLE |
| TURING CAMERA | | | |
| INTEGRATED | HIGH | LOW | HIGH |
| CIRCUIT | | | |

As indicated in Table 2, the image capturing camera 20R, the display element 1120R, and the integrated circuit 1205R consume equally high amounts of power. However, among the upper limit temperatures of the image capturing camera 20R, the display element 1120R, and the integrated circuit 1205R (“component upper limit temperature” in the figures), the upper limit temperature of the display element 1120R is the highest. After the display element 1120R, the image capturing camera 20R has the next-highest upper limit temperature, and the integrated circuit 1205R has the lowest upper limit temperature.

Accordingly, among the image capturing camera 20R, the display element 1120R, and the integrated circuit 1205R, the integrated circuit 1205R has the highest cooling priority, followed by the image capturing camera 20R, and the display element 1120R has the lowest cooling priority. In the example in FIG. 10, rotating the fan 230R causes air outside the main unit 1010 to flow downward from the top of the main unit 1010 through the holes 1012R and 1013R, and then to the outside of the main unit 1010 through the hole 1014R, as indicated by the arrows. As a result, the outside air taken in from the holes 1012R and 1013R in the main unit 1010 passes the integrated circuit 1205R, which has the highest cooling priority, draws the heat produced by the integrated circuit 1205R therefrom, and flows downward. The air then passes through the flow path 1240R between the image capturing camera 20R, which has the next-highest cooling priority, and the display element 1120R, which has the lowest cooling priority, draws the heat produced by the image capturing camera 20R and the display element 1120R therefrom, and is discharged to the outside of the main unit 1010 through the hole 1014R.

According to the foregoing configuration, in the image display device 1000 in which constituent elements having different cooling priorities from those in the first embodiment are arranged, it is not necessary to secure a space for placing the fan 230R between the image capturing camera 20R and the display element 1120R. This makes it possible to suppress an increase in the shift in the magnification between a captured image obtained by the image capturing camera 20R and a CG image generated by the image display device 1000 and superimposed on the captured image. Furthermore, in the image display device 1000, constituent elements that produce heat, such as the image capturing camera 20R, the display element 1120R, the integrated circuit 1205R, and the like, can be more efficiently cooled.

### Modification 4

An image display device according to modification 4 on the second embodiment will be described next. In the following descriptions, the same configurations as those of the image display device 1000 according to the second embodiment will be given the same reference signs, and will not be described in detail.

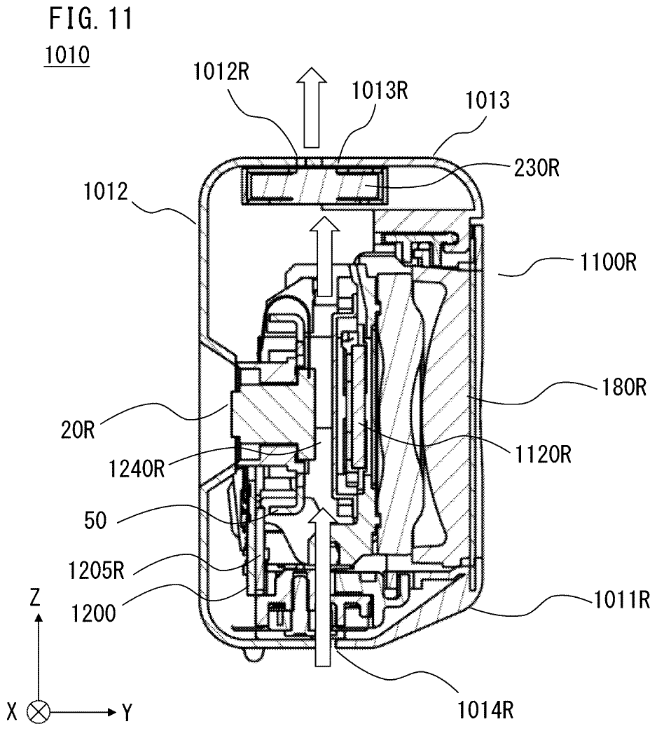

FIG. 11 is a cross-sectional view of the main unit 1010 of the image display device 1000 according to the present modification. FIG. 11 is a diagram corresponding to the cross-sectional view in FIG. 10 and described in the second embodiment. In the second embodiment, the fan 230R is operated such that air taken in from outside the device preferentially flows over the integrated circuit 1205R, which has the highest cooling priority. However, in the image display device 1000 according to the present modification, the integrated circuit 1205R is disposed lower than the display element 1120R, as illustrated in FIG. 11. Accordingly, the fan 230R may be operated such that air taken in from outside the main unit 1010 flows from below to above, as indicated by the arrow in FIG. 11.

In the present modification, outside air is taken in by the fan 230R from the hole 1014R in the image display device 1000. The air sucked in by the fan 230R passes near the integrated circuit 1205R, which has the highest cooling priority, draws the heat produced by the integrated circuit 1205R therefrom, and flows upward. The air then passes through the flow path 1240R between the display element 1120R and the image capturing camera 20R, which have lower cooling priorities, draws the heat produced by the display element 1120R and the image capturing camera 20R therefrom, and is discharged to the outside of the main unit 1010 through the holes 1012R and 1013R. The image display device 1000 according to the present modification can therefore achieve the same effects as that of the second embodiment.

Note that the present modification assumes a case where the holes 1012R and 1013R are provided in the top surfaces of the front cover 1012 and the rear cover 1013. However, the holes 1012R and 1013R may be provided in surfaces of the main unit 1010 other than the top surface, such as the front surface, the rear surface, side surfaces, or the like, as long as the holes 1012R and 1013R connect the air flow path within the main unit 1010 to the outside of the main unit 1010. Additionally, the fan 230R sends the air from one surface to another surface in the thickness direction, i.e., the direction in which the rotation axis extends. However, a fan having a structure in which air flows to a side surface using the centrifugal force of rotation, e.g., a centrifugal fan, a blower fan, or the like, may be used as the fan 230R instead.

Accordingly, the fan 230R does not overlap the image capturing camera 20R and the display element 1120R projected in the direction of the optical axis of the image capturing camera 20R (the Y-axis direction) in plan view (i.e., when viewing the image display device 1000 in the Y-axis direction). The arrangement of the fans and holes is not limited to that described above, and can be changed as appropriate, as long as the configuration is such that the air taken in from outside the main unit 1010 preferentially passes the display element 1120R, which has the highest cooling priority. Additionally, although the foregoing describes an example in which the integrated circuit 1205R is mounted on the circuit board 1200, the components on the circuit board 1200 to be cooled are not limited to the integrated circuit 1205R, and may be any mounted components that need to be cooled.

According to the image display device of the present disclosure, a display unit can be cooled efficiently while suppressing a worsening in a display magnification between an image captured by an image capturing unit and a CG image generated by the device.

### OTHER EMBODIMENTS

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-196233, filed on Nov. 8, 2024 which is hereby incorporated by reference herein in its entirety.

What is claimed is:

1. A head-mounted display device comprising:
a main unit;
an image capturing unit disposed within the main unit;
a display unit disposed within the main unit, the display unit including a display element that displays an image captured by the image capturing unit and an optical system that projects the image displayed by the display element onto an eye of a user of the head-mounted display device; and
a fan disposed within the main unit, wherein
a first opening and a second opening are formed in the main unit,
the fan is disposed in a flow path that connects the first opening and the second opening,
at least a part of the flow path is formed between the image capturing unit and the display element, and
in a plan view of the main unit seen from a direction of an optical axis of the image capturing unit, the fan does not overlap the image capturing unit and the display element.

2. The head-mounted display device according to claim 1, further comprising:
a circuit board disposed within the main unit; and
an electronic component mounted on the circuit board, wherein
in the flow path, the image capturing unit and the display element are disposed on a further toward upstream side than the electronic component.

3. The head-mounted display device according to claim 1, further comprising:
a circuit board disposed within the main unit; and
an electronic component mounted on the circuit board, wherein
in the flow path, the image capturing unit and the display element are disposed on a further toward downstream side than the electronic component.

4. The head-mounted display device according to claim 1, wherein
the display unit is disposed, in the plan view, so as to be able to move within a predetermined range relative to the main unit, and
when the display unit moves within the predetermined range, the display element and the image capturing unit overlap at any position within the predetermined range in the plan view.

5. The head-mounted display device according to claim 1, wherein the fan is disposed on a downstream side in a direction in which air flows in the flow path, and is configured to send the air from the flow path to outside the main unit.

6. The head-mounted display device according to claim 1, wherein the fan is disposed on an upstream side in a direction in which air flows in the flow path, and is configured to send air from outside the main unit to the flow path.

7. The head-mounted display device according to claim 1, wherein a set including the image capturing unit and the display unit is provided for each of a right eye and a left eye of the user.

8. The head-mounted display device according to claim 7, wherein a set including the first opening, the second opening, and the flow path is provided for each of the right eye and the left eye of the user.

9. The head-mounted display device according to claim 4, wherein when the display unit moves within the predetermined range, a center of a display surface of the display element and the optical axis of the image capturing unit coincide at any position within the predetermined range in plan view.

10. The head-mounted display device according to claim 1, wherein the fan is disposed at a top surface of the main unit, the first opening is formed in the top surface of the main unit, and the second opening is formed in a bottom surface of the main unit.

11. The head-mounted display device according to claim 1, wherein the fan is disposed at a first side surface of the main unit, the first opening is formed in the first side surface of the main unit, a fan different from the fan is disposed at a second side surface of the main unit opposite the first side surface, and the second opening is formed in the second side surface of the main unit.

12. The head-mounted display device according to claim 1, wherein the fan is disposed at a first side surface of the main unit, the first opening is formed in the first side surface of the main unit, and the second opening is formed in a bottom surface of the main unit.

13. The head-mounted display device according to claim 12, wherein a fan different from the fan is disposed at a second side surface of the main unit opposite the first side surface, a third opening is formed in the second side surface of the main unit, and a fourth opening is formed in a bottom surface of the main unit.

14. The head-mounted display device according to claim 13, wherein
the second opening is disposed at a position closer to the first side surface than the fourth opening, and
a wall that separates the flow path from a flow path connecting the third opening and the fourth opening is disposed between the second opening and the fourth opening.
